(19) United States
(12) Patent Application Publication
(10) Pub. No.: US 2018/0080276 A1
(43) Pub. Date: Mar. 22, 2018

(54) Combination Door and Frame

(71) Applicant: Roderick Tymus, Columbia, MD (US)

(72) Inventor: Roderick Tymus, Columbia, MD (US)

(21) Appl. No.: 15/712,303

(22) Filed: Sep. 22, 2017

Related U.S. Application Data
(60) Provisional application No. 62/398,180, filed on Sep. 22, 2016.

(51) Int. Cl. E06B 5/11; E05C 7/02; E06B 3/70; E06B 3/36; E06B 9/01

(52) U.S. Cl. CPC E06B 5/11; E05C 7/02; E06B 3/70; E06B 2003/7074; E06B 9/01; E06B 2003/7049; E06B 3/362

(57) ABSTRACT

A modified combination door and frame. The modified combination door includes a door that is hingedly attached to and interlocks with a frame. The frame contains a plurality of cutouts and the door includes a plurality of protrusions, wherein the protrusions and cutouts can align with one another, allowing the frame to rest flush with the door. A locking mechanism containing a lever secures the frame to the door when disposed flush together. When the locking mechanism is unsecured, the frame can move independently from the door. In some embodiments, the frame includes a coating to create an appearance that is consistent with the look of the door. The frame is composed of any suitable material that secures the entryway of a building from unauthorized intrusion.

### CROSS REFERENCE TO RELATED APPLICATION

This application claims the benefit of U.S. Provisional Application No. 62/398,180 filed on Sep. 22, 2016. The above identified patent application is herein incorporated by reference in its entirety to provide continuity of disclosure.

### BACKGROUND OF THE INVENTION

The present invention relates to combination doors and frames. More specifically, the present invention provides a door pivotally secured to an interlocking frame, wherein the frame is configured to rest flush against a surface of the door.

Many individuals desire a decorative front door for their home. However, the more desirable decorative doors are often formulated of wood. While the beauty of wood is easily obtainable, wood does not provide the security offered by steel doors. Wood can be easily broken by an intruder, thus eliminating the purpose of the door. Because of the security issues that accompany the purchasing of a wooden door, many individuals opt for purchasing a steel door. While this solves the issue of security, most individuals still desire the aesthetic benefits that come with owning a wooden door. Therefore, there is a need for an aesthetically pleasing wooden door that can provide the strength and security offered by a steel door.

To overcome the structural shortcomings associated with choosing the aesthetics of a wooden door and the aesthetic downsides of choosing a steel door, several modifications and compromises have been made to offer the benefits of each. Some of these modifications involve doors having a combination of wood and a composite metal material. Other devices look to have a wooden door with a door interior having a metallic frame, either on the perimeter of the door or throughout the door.

These modifications, however, have their downsides. One such downside is that doors that include a wooden exterior with a metallic interior, while they offer both security and aesthetic value, are not capable of being utilized separately if desired. If an individual wants the security of a steel door but wants to let in fresh air, they are required to leave their door open, thus eliminating the reasoning behind having the door. Because of this downside, a door is needed that includes the aesthetic benefits of a wooden door while offering the security of a steel door, whereby the same can be utilized together or separately as needed.

The present invention, however, overcomes the aforementioned downside of having a combination wooden and steel door similar to that of preexisting models. This is accomplished by a wooden door with a removably secured steel frame, enabling the door to be opened while the steel frame remains in place. Moreover, the steel frame fits flush within the wooden door and can be secured on the door to enable each to move in unison or can be unlocked to enable each door to be moved independently.

### SUMMARY OF THE INVENTION

In view of the foregoing disadvantages inherent in the known types of modified wooden and steel doors, the present invention provides a new combination door comprising of a door consisting of a wood or wood-like material and a frame consisting of a metal or metal-like material adapted to rest flush against the door.

It is therefore an object of the present invention to provide a modified door wherein the frame has a plurality of openings or cutouts and is connected to the door by a hinge, wherein the front facing portion of the door contains corresponding protrusions adapted to receive the openings of the frame.

It is another object of the present invention to provide a modified door comprising a locking mechanism which includes a lever that secures the frame with the door frame, and also secures the frame to the exterior entrance frame, allowing the frame and the door to move independently when unlocked and to move in unison when locked, allowing for the use of a single key.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the combination door and frame.

FIG. 2A shows a close-up view of a hinge located on the combination door and frame.

FIG. 2B shows another close-up view of a second hinge securing the frame of the combination door and frame to an exterior entrance frame.

FIG. 3A shows a perspective view of an alternative embodiment of the combination door and frame in which the frame is resting flush against the door.

FIG. 3B shows a cross sectional view of the combination door and frame in which the frame is resting flush against the door.

FIG. 4 shows a close-up view of the locking mechanism located on the combination door and frame.

### DETAILED DESCRIPTION OF THE INVENTION

Reference is made herein to the attached drawings. Reference numerals are used throughout the drawings to depict like or similar elements of the modified combination door. The figures are intended for representative purposes only and should not be considered limiting in any respect.

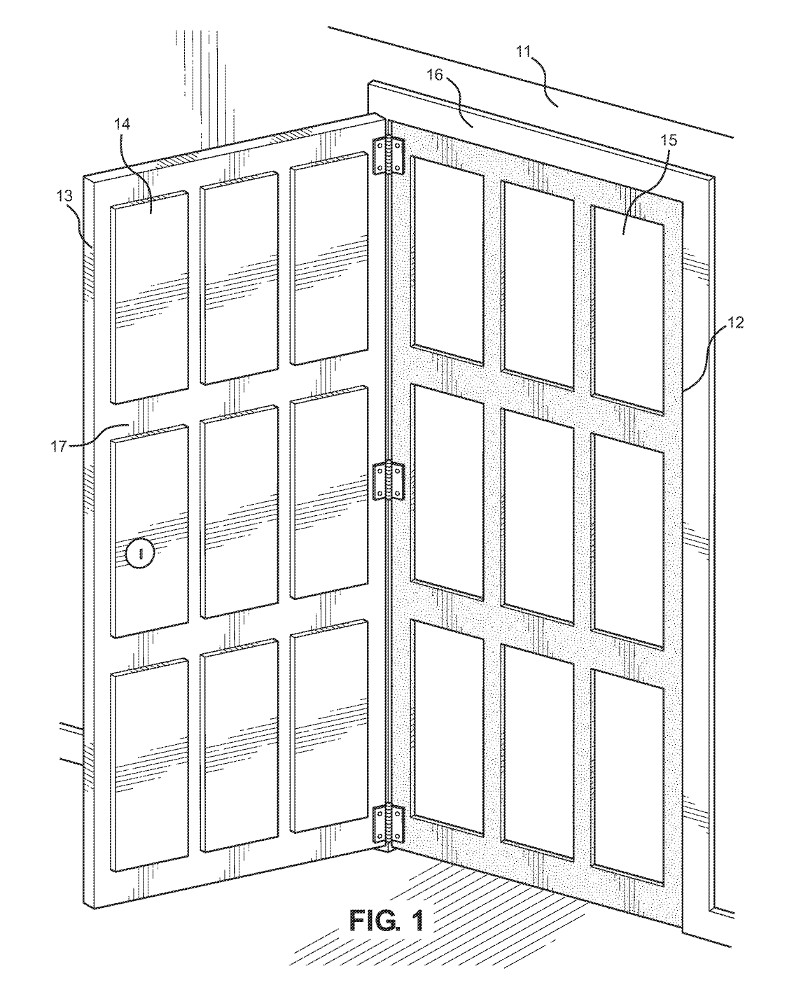

Referring now to FIG. 1, there is shown a perspective view of the modified door with the wooden door separated from the steel frame. The modified door of the present invention 11 is configured to provide the aesthetic value of a wooden door, while also offering the advantages of a metal door. The present invention 11 comprises a door 13 with features that allow for a frame 12 to be removably secured to the door 13.

The door 13 comprises a rear facing portion and a front facing portion 17, wherein the front facing portion 17 is configured to receive a frame 12. In the illustrated embodiment, the front facing portion 17 of the door 13 includes a grid pattern formed by protrusions 14 on the door 13. In the illustrated embodiment, the door 13 and protrusions 14 are composed of wood. However, in alternate embodiments, the door and protrusions are composed of any suitable material. In the illustrated embodiment, the pattern on the front facing portion 17 includes three rows and three columns of rectangular shaped protrusions. In alternate embodiments, the front facing portion can have any suitable pattern of protrusions as long as the protrusions correspond and align with openings in the frame.

The frame 12 includes a similar grid pattern created by a plurality of cutouts or openings 15 in the frame 12. In the illustrated embodiment, the frame 12 comprises an outer perimeter configured to align with the outer perimeter of the door 13. The pattern in the illustrated embodiment comprises three rows and three columns of rectangular shaped openings 15, wherein each opening aligns with a corresponding protrusion 14 in the door 13. The frame 12 is composed of a material configured to provide security and prevent intruders from entering a building. In the illustrated embodiment, the frame 12 is composed of metal. However, in alternate embodiments, the frame is comprised of any suitable rigid material.

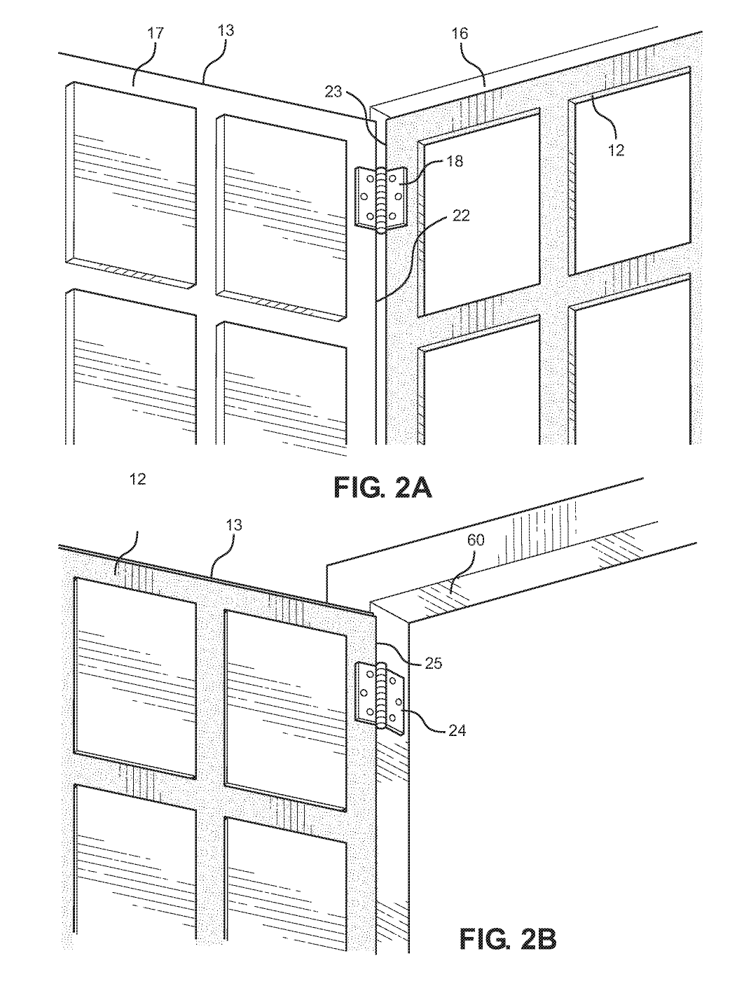

Referring now to FIGS. 2A and 2B, there are displayed closeup views of a hinge securing the frame to the door and a second hinge securing the frame of the combination door and frame to an exterior entrance frame, respectively. In the illustrated embodiment, the frame 12 is attached to the door 13 by one or more hinges 18, thereby allowing for the frame 12 to pivot relative to the door 13. The hinges 18 on the frame 12 provide for the attachment of the frame to the door 13, allowing the frame 12 and door 13 to move independently from one another while remaining attached. The hinges 18 are located in between the interior edge 23 of the frame 12 and the interior edge 22 of the door 13. In some embodiments, a second hinge 24 is secured to an exterior edge 25 of the frame 12 and adapted to secure to an exterior entrance frame 60.

The frame 12 can be utilized when secured to the wooden door 13 or when detached from the door 13. This provides convenience when it is desired to have the door 13 open but still intended to have the security offered by the frame 12. When in use as security, the frame 12 is secured to the exterior entrance frame when used for preventing passage through the entrance. When the frame 12 is not in use for security purposes, the frame 12 is detached from the exterior entrance frame such that the frame 12 pivots freely with the door 13.

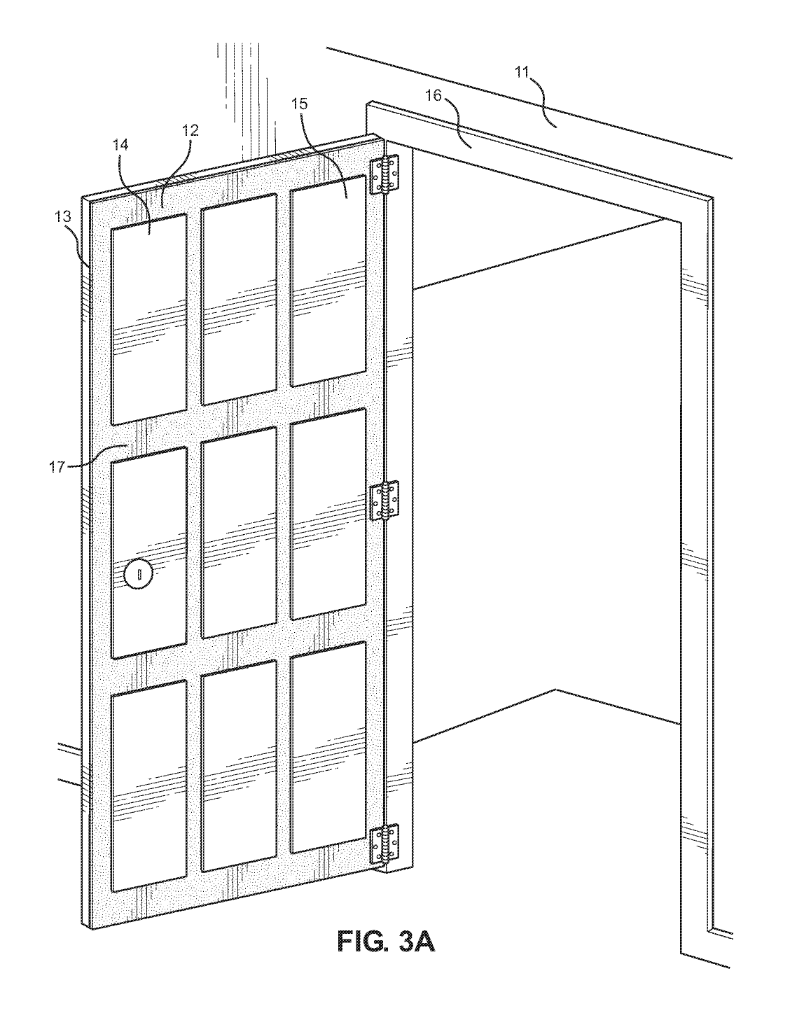

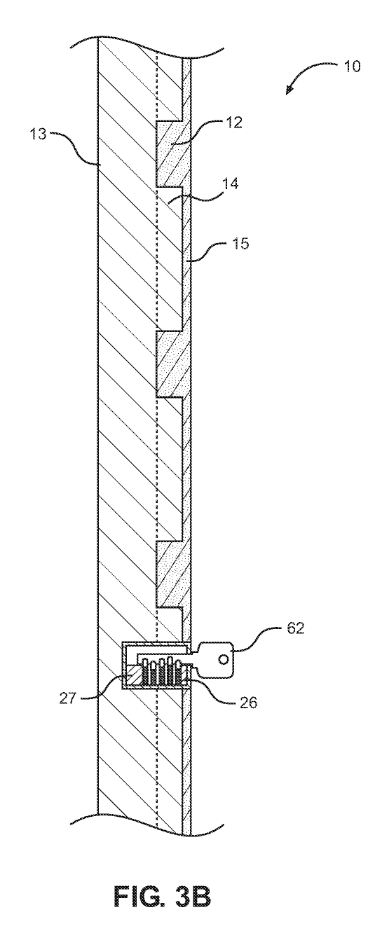

Referring now to FIGS. 3A and 3B, there is shown a perspective view of the door of the present invention, wherein the frame is secured flush onto the door and a cross sectional view of the combination door and frame in which the frame is resting flush against the door, respectively. The door 13 and frame 12 each comprise a key aperture 26, 27 that is adapted to align with one another such that they overlap and can accept a singular key 62 through the key aperture 26, 27 of both the door 13 and the frame 12. In this way, a single key can be used to lock and unlock the combination door and frame 12. In embodiments including the exterior entrance frame, the key aperture 26 of the frame 12 is adapted to align with a recess in the exterior entrance frame adapted to receive a bolt or lock from the frame 12, thereby securing the frame 12 to the exterior entrance frame.

In the illustrated embodiment, the frame 12 is adapted to be covered with a decorative pattern using any paint or staining material to blend or match the appearance of the front facing portion 17 of the door 13. Moreover, the door 13 can be formed of a composite material (not restricted to wood) and the frame 12 is capable of being composed of a variety of material types, such as steel.

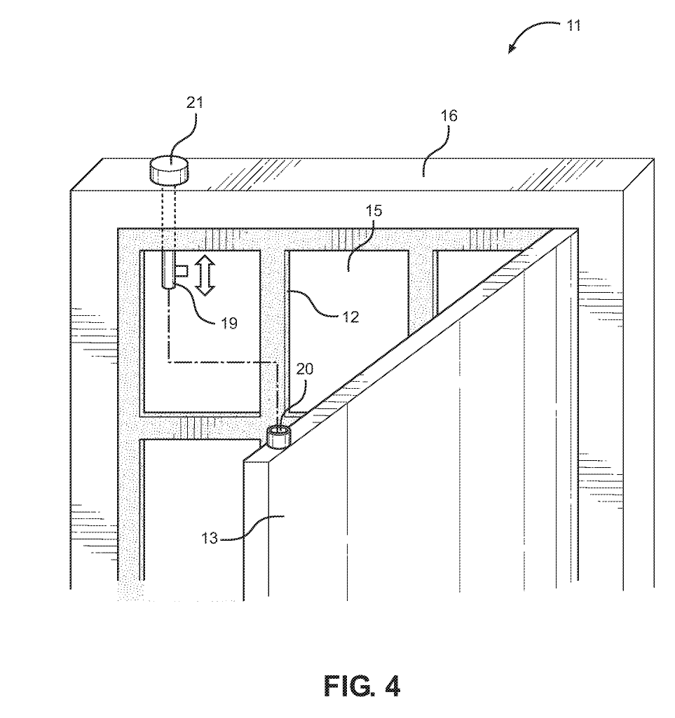

Referring now to FIG. 4, there is shown a close-up view of the locking mechanism of the combination door and frame. The door 13 and the frame 12 move in unison when locked together, and move independently when unlocked. In the illustrated embodiment, the locking mechanism includes a lever 19 that secures the door 13 and the frame 12 together. The lever 19 is movably attached within the frame 12 and extends and retracts through an opening on the frame 12. The door 12 comprises a cutout configured to receive the lever 19 therein, such that the lever 19 can be raised and secured within the cutout 20 of the door 13 when the door and frame 12 are resting flush together. In the illustrated embodiment, the locking mechanism is positioned at the upper end of the combination door and frame. Similarly, in some embodiments, the projecting lever 19 on the frame 12 can be raised and secured within a cutout 21 on the upper surface of the exterior entrance frame 16, allowing the frame 12 to remain secure to the exterior entrance frame 16 when the frame 12 and door 13 are unattached.

Overall, the present invention provides a modified combination door 11 that provides benefits where most doors are only capable of presenting a singular beneficial feature. The present invention offers the aesthetic advantage of offering a wooden door with the benefits of a metal door. This is accomplished by providing a wooden door with a front facing side 17 having protrusions 14 specific for receiving a steel door frame 12, having a similar pattern 15. Further, the present invention enables the wooden door 13 to be separated and operated independently from the steel frame 12 as needed. Moreover, the steel frame 12 can include a coating or covering thereon to blend in with the door. The door itself can be formed of a variety of suitable materials. The present invention provides a benefit over similar doors in that only a single key is required when the steel frame 12 and wooden door 13 rest flush against each other.

The foregoing descriptions of specific embodiments of the present invention have been presented for purposes of illustration and description. They are not intended to be exhaustive or to limit the present invention to the precise forms disclosed, and many modifications and variations are possible in light of the above teaching. The exemplary embodiment was chosen and described to best explain the principles of the present invention and its practical application, to thereby enable others skilled in the art to best utilize the present invention and various embodiments with various modifications as are suited to the particular use contemplated.

I claim:

1) A combination door and frame, comprising:
a frame having a plurality of openings;
a door comprising a rear facing portion and a front facing portion;
the front facing portion of the door comprising a plurality of protrusions, wherein the plurality of protrusions is aligned with the plurality of openings such that the frame is adapted to rest flush against the front facing portion of the door;
a hinge or plurality of hinges securing the frame to the door;
a locking mechanism configured to removably secure the door to the frame;
wherein the frame and the door each comprise a key aperture adapted to align with one another.

2) The combination door and frame of claim 1, wherein the door is composed of a wood material.

3) The combination door and frame of claim 1, wherein the frame is entirely composed of a metal material.

4) The combination door and frame of claim 3, wherein one or more hinges connecting the door to the frame is located between the interior of the door and the interior of the frame.

5) The combination door and frame of claim 3, wherein the frame includes a coating thereon to match the appearance of the front facing portion of the door.

6) The combination door and frame of claim 1, wherein the locking mechanism comprises a lever that is movably secured to the frame such that the lever extends and retracts from an opening within the frame and is configured to extend into a cutout disposed on the door when the frame and the door are resting flush against one another, allowing the frame and the door to move in unison when locked and to move independently when unlocked.
